(19) United States
(12) Patent Application Publication
(10) Pub. No.: US 2010/0199196 A1
(43) Pub. Date: Aug. 5, 2010

(54) Method for delivering graphic intensive web type content to thin clients

(75) Inventor: Mark Stephen Thompson, Rancho Santa Margarita, CA (US)

Correspondence Address: PATENT LAW OFFICE OF D.R. HASZKO;c/o Dennis R. Haszko, 499 MOSHER HILL ROAD, FARMINGTON, ME, 04938, US

(73) Assignee: Thompson Aerospace, Irvine, CA (US)

(21) Appl. No.: 12/553,094

(22) Filed: Sep. 3, 2009

Related U.S. Application Data
(60) Provisional application No. 61/094,400, filed on Sep. 4, 2008.

(51) Int. Cl. G06F 15/16; G06F 3/01

(52) U.S. Cl. 715/760; 709/203

(57) ABSTRACT

A method and apparatus to provide graphic intensive web type content to a microprocessor base terminal that includes a screen and input device(s), herein after referred to as a thin client, with a fast refresh rate. To achieve this, content is preprocessed into a picture type of web like page, such as JPEG, specific for each type of client. Additionally, this method requires the thin client to be attached to content server over a high speed network connection or has a fast connection to locally stored content.

### CROSS-REFERENCE TO RELATED APPLICATIONS

This application claims the benefits of provisional patent application Ser. No. 61/094,400 file Sep. 4, 2008 by the present inventor.

### OTHER REFERENCES

None

### FEDERALLY SPONSORED RESEARCH

Not Applicable

### SEQUENCE LISTING OR PROGRAM

Not Applicable

### BACKGROUND

1. Field of the Invention

A means to provide graphic intensive web type content to a microprocessor base terminal that includes a screen and input device(s), herein after referred to as a thin client, with a fast refresh rate. To achieve this content is preprocessed into a picture type of web like page, such as JPEG, specific for each type of client. Additionally, this method requires the thin client to be attached to content server over a high speed network connection or has a fast connection to locally stored content.

2. Objects and Advantages

The rendering of graphics displays on electronic computing devices has become prevalent. Many means, such as HTML, have been created to perform rendering a graphical image with minimum bandwidth usage. These methods presume slow network connections and thereby rely on large amounts of processing power at the terminal device. This reduces the amount of data required to be moved from the storage device to the terminal device. As networks have become faster and the usage of thin clients (i.e., clients with less than 1000 MIPS of processing power with non-standard display sizes) have degraded the performance and viewing experience for the user. Normally a thin client takes a large amount of time to process and render a HTML type page. Further, after the page is rendered the displayed page is not in a format easily viewed on the client due to the fact the HTML type page is designed and coded for a more powerful client, such as a modern personal computer and not a specific thin client.

In view of the foregoing, it is therefore the object of this method to provide a rich user experience utilizing a thin client device on a network, or attached media storage, with a large amount of bandwidth to transport data. In order to achieve this fast rendering, this method utilizes a combination of hardware and/or software acceleration to produce an image in a fraction of the time with significantly less processing power. The image is produced either prior to or in real time by another computational means separate from the thin client. This allows the thin client to use its graphical accelerator to render the complete image.

Additionally, method provides preprocessed content into a picture type of web like page, such as JPEG, specific to the type of client, thereby maintaining the information in an easily viewable display. The usage of single static graphic, such as a JPEG, or for moving objects a movie, such as a MPEG, reduces the required processing power on the client's embedded device.

On pages where the user is needed to input text an OSD (on screen display) overlay function provides the user a means to input text on top of the image. Additionally, this method provides for multiple overlay windows, content can be format to make maximum advantage of the graphical windows to provide the best possible user experience. The typical accelerator provided in thin clients is a JPEG image processor or a movie player. With the usage of these accelerators it is possible to provide a rich user experience utilizing a minimal amount of processing power.

In addition, the clients never require software upgrades as original image is always preprocessed in a known format.

The present invention will be described more fully hereinafter, this invention may, however, be embodied in many different forms and should not be construed as limited to the embodiments set forth herein; rather, these embodiments are provided so that this disclosure will be thorough and complete, and will fully convey the scope of the invention to those skilled in the art.

### DETAILED DESCRIPTION—OPERATION

Web like content is developed on a PC or similar device as electronic pictures, in formats such as JPEG, or as digital movies, in formats such as MPEG. Thereafter, a series of control files are developed to link these pictures/movies together. In the control file various attributes, dependant on the thin-client type and applications, are defined and populated. These pictures, movies and control files are then placed on a storage device, network attached storage, or network server.

A thin client attached directly to this storage device, network to a storage device, or content server then pulls up the first image (either a picture or movie file) and control file, predefined in the thin client, upon power-up. The thin client then renders, using its embedded hardware and or software graphics accelerator, the first image. As user input is received at the thin client the control file attributes are used to change the graphical display and/or to branch to another image.

In the case a new image is required the thin client merely pulls the image off the storage device, network storage, or content server and displays it. As additional user input is made, the thin client utilizes the control file to change the existing displayed image, based on the attribute mapped to the user's input or pulls up and displays a different image, picture or movie.

Additionally, in order to maintain a reasonably sized thin client control file, this methods provides for the ability to branch between control files. For example, the present control file is “Alpha.cnt”, within that control file are attributes for the image “Red”. The next user input, mapped to control file “Alpha” attributes for “Red” direct the thin client to pull image “Blue” and start using “Bravo.cnt” as the control file. The thin client then pulls down the image “Blue” and control file “Bravo.cnt”, displays the “Blue” image and loads “Bravo.con” as the active control file.

To provide the user to return to previous images, the thin client maintains a stack of prior pages and control files the user came from. Thus, if the user input commanded the thin client to go back one page, the thin client would pop the stack, in our example, “Red” and “Alpha.cnt” would pop out. The thin client then pulls down the “Red” image and the “Alpha.cnt” files, displays the “Red” image and loads the “Alpha.cnt” as the active control file.

The thin client, if equipped with an OSD engine, can use the OSD engine to display text and graphics over the top of the rendered image. This is performed by use of the control file. The thin client displays the underlying image and the control file attributes for that image provide the characteristics of the overlay. For example, the image “Blue” is displayed and the attributes for in the “Bravo.cnt” active control file for “Blue” have a 500 pixel wide by 15 pixel tall overlay box colored grey for data entry. The thin client displays the “Blue” image and opens up a 500 by 15 pixel box on top of the image for data entry.

If the client is equipped with multiple accelerators or an accelerator it can perform more than one decode at a time then the preprocessed content would be stored in a method that would provide the best experience for the user.

### OPERATION—PREFERRED EMBODIMENT

Many modifications and other embodiments of the invention will come to the mind of one skilled in the art having the benefit of the teachings presented in the foregoing descriptions and the associated drawings. It is to be understood that the invention is not to be limited to the specific embodiments disclosed, and that modifications and embodiments are intended to be included within the scope of the appended claims.

That which is claimed is:

1. A utility to provide graphic images, text images, and moving images on a thin client in a format specific to the client and to mimic an HTML, FLASH, Java, or similar implementations user experience.

2. The utility according to claim 1, wherein the thin client that has a type of acceleration to reduce the load on the CPU wherein the acceleration could be a JPEG decoder.

3. The utility according to claim 1, wherein the thin client that has a type of acceleration to reduce the load on the CPU wherein the acceleration could be a MPEG player.

4. The utility according to claim 1, wherein the thin client that has a type of acceleration to reduce the load on the CPU wherein the acceleration could be a Quick Time.

5. The utility according to claim 1, wherein the thin client that has a type of acceleration to reduce the load on the CPU wherein the acceleration could be another type of digital movie player.

6. The utility according to claim 1, wherein the thin client that has a type of acceleration to reduce the load on the CPU wherein the acceleration could be any type of hardware acceleration capable of producing a graphics images.

7. The utility of claim 1, wherein the thin client has a function to overlay an OSD over the top of a rendered image.

8. The utility of claim 7, wherein the OSD could provide both text and graphics to mimic a web based experience.

9. The utility of claim 7, wherein the user could enter information using the OSD function

10. The utility of claim 1, wherein the attachment to the stowage content provides a fast and short delay in content transmission.

11. The utility of claims 9 and 10, wherein the thin client is directly attached to content in a fast stowage device.

12. The utility of claim 11, wherein the thin client graphical display content is correctly formatted for the thin client to provide a rich user experience thru usage of claim 1, and claim 9.

13. The utility of claim 12, the content would be preprocessed in a format to provide for a rich user experience based on the specific hardware in the client.

14. The utility of claim 1, wherein the thin client graphical display content is created in real time by a processing device and provided over a fast network.

15. The utility of claim 14, wherein the thin client graphical display content has been correctly format for the thin client to provide a rich user experience thru usage of claim 1, and claim 9.

16. The utility of claim 1, wherein the local area network has any number of thin clients attached over a fast network, speeds greater than 10 Mb/s.

17. The utility of claim 1, wherein the wide area network has any number of thin clients attached over a fast network, speeds greater than 10 Mb/s.

18. The utility of claim 10 thru claim 18, wherein a server device capable of serving up large continuous files very fast to thin clients.

19. The utility of claim 19, wherein the server device would use solid state stowage to reduce access and seeks times in lieu of spinning media.
